(19) United States
(12) Patent Application Publication
(10) Pub. No.: US 2013/0316039 A1
(43) Pub. Date: Nov. 28, 2013

(54) Mold-Tool System Including Cooling-Insert Assembly being Positioned Proximate to Nozzle Assembly

(71) Applicants: Paul R. Blais, South Burlington, VT (US); Darrin Albert Macleod, Jeffersonville, VT (US)

(72) Inventors: Paul R. Blais, South Burlington, VT (US); Darrin Albert Macleod, Jeffersonville, VT (US)

(73) Assignee: HUSKY INJECTION MOLDING SYSTEMS LTD., Bolton, ON (CA)

(21) Appl. No.: 13/981,669

(22) PCT Filed: Feb. 14, 2012
(86) PCT No.: PCT/US12/24948

§ 371 Date: Jul. 25, 2013

Related U.S. Application Data
(60) Provisional application No. 61/443,536, filed on Feb. 16, 2011.

(51) Int. Cl. B29C 45/74

(52) U.S. Cl. CPC B29C 45/74
USPC 425/549

(57) ABSTRACT

A mold-tool system (100), comprising: a runner assembly (102) having: a nozzle assembly (104); and a cooling-insert assembly (106) being positioned proximate to the nozzle assembly (104), the cooling-insert assembly (106) being configured to provide, in use, uniform cooling to the nozzle assembly (104). Several potential advantages may be realized with the above arrangement: (i) improvement of hot runner balance by creating a more uniform temperature on all drops, (ii) reduction of energy usage in the hot runner by giving ability to include insulating features, geometry, or materials between the cooling medium and the hot components, and/or (iii) simplification of design since water lines may now be in line with nozzle assemblies.

### TECHNICAL FIELD

An aspect generally relates to (but is not limited to) molding systems and or mold-tool system.

### SUMMARY

The inventors have researched a problem associated with known molding systems that inadvertently manufacture bad-quality molded articles or parts. After much study, the inventors believe they have arrived at an understanding of the problem and its solution, which are stated below, and the inventors believe this understanding is not known to the public.

A current problem is that hot runner cooling is not adequately balanced. The current cooling layouts may result in outer drops being subjected to increased cooling when compared to the inner drops on a hot runner. Also, given the current technology of gundrilling for cooling lines, it may be difficult to eliminate this feature. The final result may be for the outer drops to have smaller part weights than the inner drops. The non-uniform cooling may result in a large temperature variation in the hot runner plates. This variation may result in temperature differences in the manifold and nozzle housing, which may adversely affect the balance of the hot runner.

According to one aspect, there is provided a mold-tool system (100), comprising: a runner assembly (102) having: a nozzle assembly (104); and a cooling-insert assembly (106) being positioned proximate to the nozzle assembly (104), the cooling insert (106) being configured to provide, in use, uniform cooling to the nozzle assembly (104).

Several potential advantages may be realized with the above arrangement: (i) improvement of hot runner balance by creating a more uniform temperature on all drops, (ii) reduction of energy usage in the hot runner by giving ability to include insulating features, geometry, or materials between the cooling medium and the hot components, and/or (iii) simplification of design since water lines may now be inline with nozzle assemblies.

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

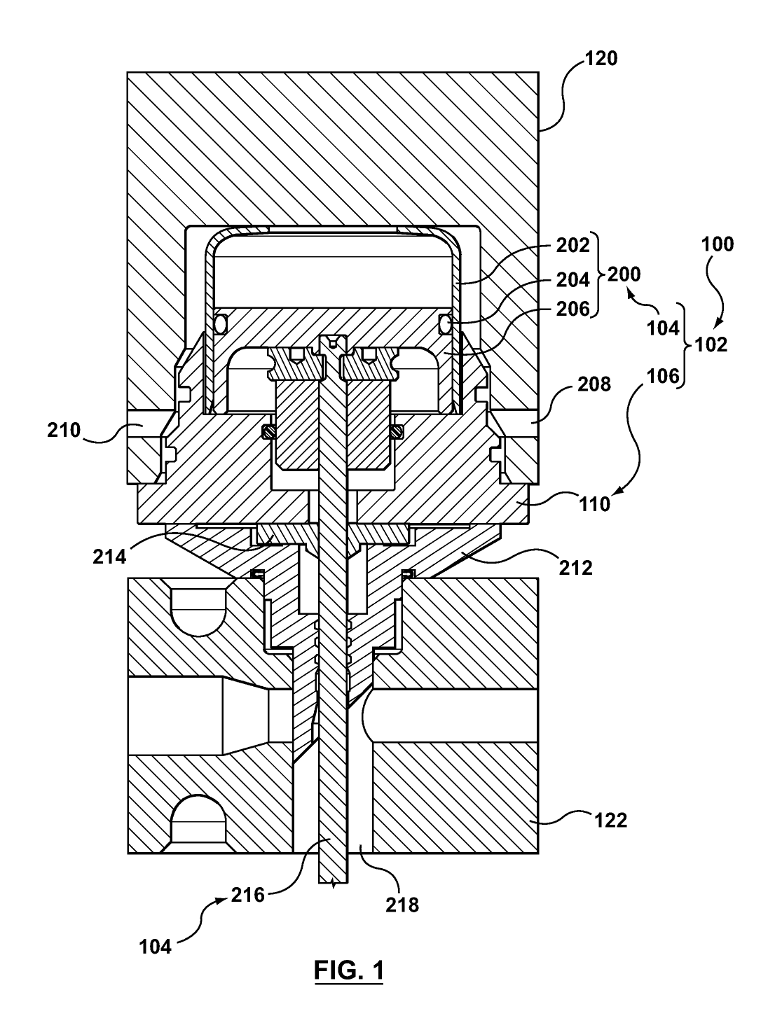

FIGS. 1, 2, 3 depict schematic representations of a mold-tool system (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIGS. 1, 2, 3 depict the schematic representations of the mold-tool system (100). The mold-tool system (100) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising”. The word “comprising” is a transitional phrase or word that links the preamble of a patent claim to the specific elements set forth in the claim which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

The definition of the mold-tool system (100) is as follows: a system that may be positioned and/or may be used in an envelope defined by a platen system of the molding system, such as an injection-molding system for example. The platen system may include a stationary platen and a movable platen that is moveable relative to the stationary platen.

FIG. 1 depicts a cross sectional view of the mold-tool system (100). Generally, according to the examples depicted in FIGS. 1, 2, 3, the mold-tool system (100) may include (and is not limited to): a runner assembly (102). The runner assembly (102) may have (and is not limited to): a nozzle assembly (104). The runner assembly (102) may also have (and is not limited to) a cooling-insert assembly (106). The cooling-insert assembly (106) may be positioned proximate to the nozzle assembly (104). The cooling-insert assembly (106) may be configured to provide, in use, uniform cooling to the nozzle assembly (104). Specific options are described below:

In accordance with the example depicted in FIG. 1, the nozzle assembly (104) may include (and is not limited to): a valve-stem assembly (216), and a stem-actuator assembly (200) that may be configured to actuate movement of the valve-stem assembly (216). The stem-actuator assembly (200) may include, for example, an air cylinder (202), a piston seal (204) and a piston (206) that all cooperate to actuate movement of the valve-stem assembly (216) in accordance to methods known to personal of skill in the art, so therefore the details for the stem-actuator assembly (200) is not described here in any detail. It will be appreciated that other mechanism may be used for the stem-actuator assembly (200). The nozzle assembly (104) may also include a back-up pad (212) and a stem seal (214) the back-up pad (212) is Placed between the stem-actuator assembly (200) and a manifold-plate assembly (122). The stem seal (214) is positioned or supported by the back-up pad (212) and the stem seal (214) slidably receives the valve-stem assembly (216). The manifold-plate assembly (122) defines a melt channel (218) used for conveying a melt from a melt preparation assembly (known and not depicted) to a mold assembly (known and not depicted). The valve-stem assembly (216) is slidably received in the melt channel (218) of the manifold-plate assembly (122).

In accordance with the example depicted in FIG. 1, the cooling-insert assembly (106) may include (and is not limited to): a backing-plate cooling insert assembly (110). The backing-plate cooling insert assembly (110) may be configured for: (i) placement, at least in part, in a backing plate (120) of the runner assembly (102), and (ii) positioning proximate to the nozzle assembly (104). An inlet (208) for a cooling line (209) and an outlet (210) for the cooling line (209) may be provided by the backing plate (120).

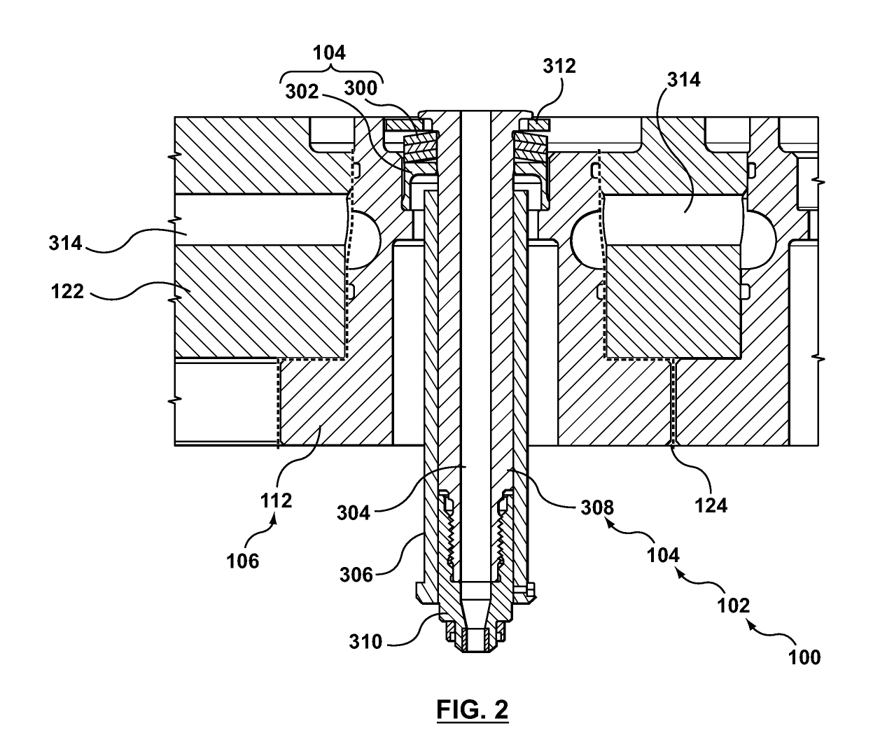

In accordance with the example depicted in FIG. 2, the cooling-insert assembly (106) may include (and is not limited to): a nozzle-drop cooling insert (112). The nozzle-drop cooling insert (112) may be configured for placement, at least in part, between the manifold-plate assembly (122) of the runner assembly (102) and the nozzle assembly (104).

The nozzle assembly (104) may include, by way of example (and is not limited to) the following components: a spring assembly (300), a nozzle Locating insulator (302), a nozzle housing (308) defining a nozzle melt channel (304), a nozzle heater (306) connected with the nozzle housing (308), a nozzle tip (310), an anti-rotation tab (312) configured to prevent rotation of the nozzle housing (308); the components identified in this paragraph are known to persons of skill in the art, and so will not be further described in any further detail. The manifold-plate assembly (122) may define a plate cooling mechanism (314) having a cooling fluid.

It will be appreciated that according to an option, the cooling-insert assembly (106) may include both the backing-plate cooling insert assembly (110) and the nozzle-drop cooling insert (112) being used or installed at same time.

In accordance with another option, as depicted in FIG. 2, the cooling-insert assembly (106) may include (and is not limited to): a thermal-barrier coating (124). The thermal-barrier coating (124) may be applied, at least in part, to a surface of the cooling-insert assembly (106), such as an outer surface and an inner surface or both. (106). The thermal-barrier coating (124) may be configured to minimize, in use, heat transfer between the manifold-plate assembly (122) and the cooling-insert assembly (106).

In accordance with another option, the cooling-insert assembly (106) may include (and is not limited to): a backing-plate cooling insert assembly (110). The backing-plate cooling insert assembly (110) may be configured for: (i) placement, at least in part, in a backing plate (120) of the runner assembly (102), and (ii) positioning proximate to the nozzle assembly (104). IN addition, the cooling-insert assembly (106) may include (and is not limited to): a thermal-barrier coating (124). The thermal-barrier coating (124) may be applied, at least in part, to a surface of the cooling-insert assembly (106). The thermal-barrier coating (124) may be configured to minimize, in use, heat transfer between the cooling-insert assembly (106) and the back-up pad (212).

An example of the thermal-barrier coating (124) is NitroCoat (TRADEMARK), which is manufactured by Toefco Engineered Coating Systems, Inc., 1220 N. 14th Street, Niles, Mich. 49120 USA, telephone (269) 683-0188.

It will be appreciate that the nozzle-drop cooling insert (112) may include the thermal-barrier coating (124) in accordance with one option. It will be appreciate that the backing-plate cooling insert assembly (110) may include the thermal-barrier coating (124) in accordance with another option.

It will also be appreciated that in accordance with another option, the cooling-insert assembly (106) (as depicted in FIG. 1 or 2) may include (and is not limited to): a relatively lower thermal conductivity material. The relatively lower thermal conductivity material may have a relatively lower thermal conductivity than the thermal conductivity of the material of the nozzle assembly (104) and the manifold-plate assembly (122). The relatively lower conductivity material may be configured to minimize, in use, heat transfer between the nozzle assembly (104) and the manifold-plate assembly (122).

According to another option, the cooling-insert assembly (106) includes (and is not limited to: a relatively lower thermal conductivity material. The relatively lower thermal conductivity material may have a relatively lower thermal conductivity than the thermal conductivity of a material of the back-up pad (212). The relatively lower conductivity material may be configured to minimize, in use, heat transfer between the back-up pad (212) and the backing plate (120).

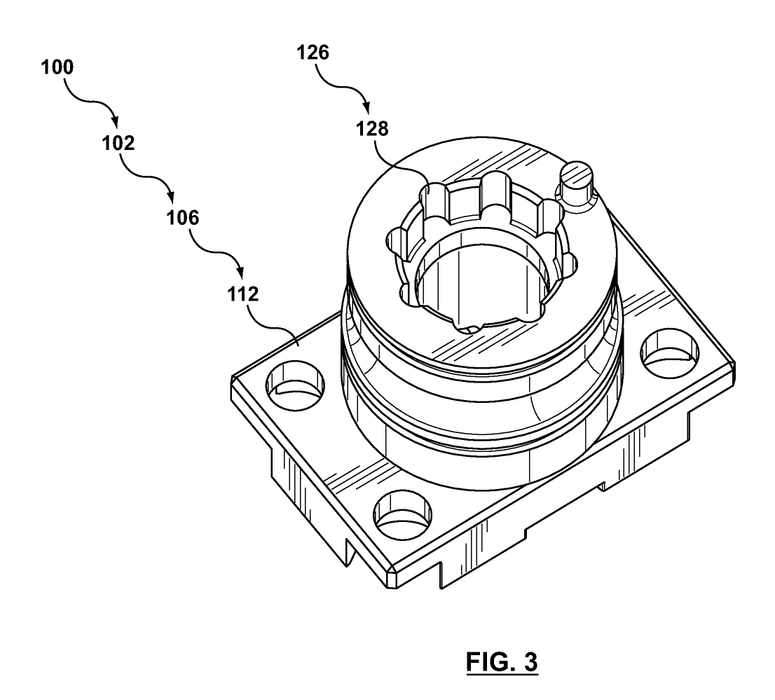

FIG. 3 depicts a perspective view of the mold-tool system (100), in which the cooling-insert assembly (106) may include (and is not limited to): a feature (126). The feature (126) may be configured to minimize, in use, heat transfer between the nozzle assembly (104) and the cooling-insert assembly (106). The feature (126) may be machined to the cooling-insert assembly (106). The feature (126) may include (by way of example and not limited to): a scalloped portion (128).

It will be appreciated that the assemblies and modules described above may be connected with each other as may be required to perform desired functions and tasks that are within the scope of persons of skill in the art to make such combinations and permutations without having to describe each and every one of them in explicit terms. There is no particular assembly, components, or software code that is superior to any of the equivalents available to the art. There is no particular mode of practicing the inventions and/or examples of the invention that is superior to others, so long as the functions may be performed. It is believed that all the crucial aspects of the invention have been provided in this document.

It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising”. It is noted that the foregoing has outlined the non-limiting embodiments (examples). The description is made for particular non-limiting embodiments (examples). It is understood that the non-limiting embodiments are merely illustrative as examples.

What is claimed is:

1. A mold-tool system (100), comprising:
a runner assembly (102) having:
a nozzle assembly (104); and
a cooling-insert assembly (106) being positioned proximate to the nozzle assembly (104), the cooling-insert assembly (106) being configured to provide, in use, uniform cooling to the nozzle assembly (104).

2. The mold-tool system (100) of any preceding claim, wherein:
the cooling-insert assembly (106) includes:
a backing-plate cooling insert assembly (110) being configured for:
(i) placement, at least in part, in a backing plate (120) of the runner assembly (102), and
(ii) positioning proximate to the nozzle assembly (104).

3. The mold-tool system (100) of any preceding claim, wherein:
the cooling-insert assembly (106) includes:
a nozzle-drop cooling insert (112) being configured for placement, at least in part, between a manifold-plate assembly (122) of the runner assembly (102) and the nozzle assembly (104).

4. The mold-tool system (100) of any preceding claim, wherein:
the cooling-insert assembly (106) includes:
a backing-plate cooling insert assembly (110) being configured for:
(i) placement, at least in part, in a backing plate (120) of the runner assembly (102), and
(ii) positioning proximate to the nozzle assembly (104); and
a nozzle-drop cooling insert (112) being configured for placement, at least in part, between a manifold-plate assembly (122) of the runner assembly (102) and the nozzle assembly (104).

5. The mold-tool system (100) of any preceding claim, wherein:
the cooling-insert assembly (106) includes:
a thermal-barrier coating (124) being applied, at least in part, to an outer surface of the cooling-insert assembly (106), the thermal-barrier coating (124) being configured to minimize, in use, heat transfer between a manifold-plate assembly (122) and the cooling-insert assembly (106).

6. The mold-tool system (100) of any preceding claim, wherein:
the cooling-insert assembly (106) includes:
a nozzle-drop cooling insert (112) being configured for placement, at least in part, between a manifold-plate assembly (122) of the runner assembly (102) and the nozzle assembly (104); and
a thermal-barrier coating (124) being applied, at least in part, to a surface of the cooling-insert assembly (106), the thermal-barrier coating (124) being configured to minimize, in use, heat transfer between the nozzle assembly (104) and the cooling-insert assembly (106).

7. The mold-tool system (100) of any preceding claim, wherein:
the cooling-insert assembly (106) includes:
a backing-plate cooling insert assembly (110) being configured for:
(i) placement, at least in part, in a backing plate (120) of the runner assembly (102), and
(ii) positioning proximate to the nozzle assembly (104); and
a thermal-barrier coating (124) being applied, at least in part, to a surface of the cooling-insert assembly (106), the thermal-barrier coating (124) being configured to minimize, in use, heat transfer between the cooling-insert assembly (106) and a back-up pad (212).

8. The mold-tool system (100) of any preceding claim, wherein:
the cooling-insert assembly (106) includes:
a backing-plate cooling insert assembly (110) being configured for:
(i) placement, at least in part, in a backing plate (120) of the runner assembly (102), and
(ii) positioning proximate to the nozzle assembly (104); and
a thermal-barrier coating (124) being applied, at least in part, to a surface of the cooling-insert assembly (106), the thermal-barrier coating (124) being configured to minimize, in use, heat transfer between the backing plate (120) and the cooling-insert assembly (106)

9. The mold-tool system (100) of any preceding claim, wherein:
the cooling-insert assembly (106) includes:
a relatively lower thermal conductivity material having a relatively lower thermal conductivity than a thermal conductivity of a material of the nozzle assembly (104), the relatively lower conductivity material being configured to minimize, in use, heat transfer between the nozzle assembly (104) and a backing plate (120).

10. The mold-tool system (100) of any preceding claim, wherein:
the cooling-insert assembly (106) includes:
a relatively lower thermal conductivity material having a relatively lower thermal conductivity than a thermal conductivity of a material of a back-up pad (212), the is relatively lower conductivity material being configured to minimize, in use, heat transfer between the back-up pad (212) and a backing plate (120).

11. The mold-tool system (100) of any preceding claim, wherein:
the cooling-insert assembly (106) includes:
a feature (126) configured to minimize, in use, heat transfer between the nozzle assembly (104) and the cooling-insert assembly (106).

12. The mold-tool system (100) of any preceding claim, wherein:
the cooling-insert assembly (106) includes:
a feature (126) being machined to the cooling-insert assembly (106), the feature (126) being configured to minimize, in use, heat transfer between the nozzle assembly (104) and the cooling-insert assembly (106).

13. The mold-tool system (100) of any preceding claim, wherein:
the cooling-insert assembly (106) includes:
a feature (126) being machined to the cooling-insert assembly (106), the feature (126) being configured to minimize, in use, heat transfer between the nozzle assembly (104) and the cooling-insert assembly (106),
the feature (126) includes:
a scalloped portion (128).

14. A molding system having the mold-tool system (100) of any one of claims 1 to 11.
